(19) United States
(12) Patent Application Publication
(10) Pub. No.: US 2012/0013973 A1
(43) Pub. Date: Jan. 19, 2012

(54) ELECTRO-OPTICAL DISPLAY

(75) Inventor: Jong-Souk Yeo, Corvallis, OR (US)

(73) Assignee: Hewlett-Packard Development Company L.P.

(21) Appl. No.: 13/259,316

(22) PCT Filed: Oct. 1, 2009
(86) PCT No.: PCT/US09/59259

§ 371 Date: Sep. 23, 2011

(51) Int. Cl. G02F 1/167; H01J 9/20

(52) U.S. Cl. 359/296; 445/24

(57) ABSTRACT

A display has colorants in fluid-filled cells. The display has front and back surfaces, and each cell extends to at least one surface of the display. The cells at least partially overlap so that for at least a portion of the front surface, a line perpendicular to the front surface passes through more than one cell.

### DESCRIPTION OF THE RELATED ART

Some displays, sometimes called electronic paper, or electronic ink displays (for example, for general signage, electronic billboards, and e-book readers), typically draw power only when the image is changing, and the image is stable when power is not being applied. One example technology is electrophoretic displays, in which charged pigments move in a fluid in response to an electric field. For example, an electrophoretic display may have charged pigment particles in a dielectric fluid, sandwiched between two conductive plates. A first plate is at the viewing surface and is transparent, and the second plate is behind the display. When an electric field is formed between the plates, the charged pigment particles move through the fluid (due to the applied electric field) toward the plate having the opposite charge. For example, if the fluid is dark and the charged particles are white, when the particles are located at the viewing surface, the display appears white, and when the particles are away from the viewing surface, the display appears black. The display may be divided into cells, with the electric field across each cell separately controllable.

Typically, for full color, electrophoretic displays require stacked layers of cells, with an intermediate layer of transparent electrode plates. Multiple layers of cells with more than one layer of transparent electrodes add cost and complexity. In addition, there may be a need for a clear state for cells in at least one of the layers. Typically, for a clear state, particles are moved transversely out of the line of sight. This may require additional electrodes between adjacent cells, adding cost and complexity.

There is an ongoing need to lower costs, reduce complexity, improve manufacturability, and to provide multi-color and full-color displays.

### BRIEF DESCRIPTION OF THE DRAWINGS

FIG. 1A is a cross-section side view of part of an example embodiment of a display.

FIG. 1B is a front view of the example display of FIG. 1A.

FIG. 1C is the example embodiment of FIG. 1A with a different electrode state.

FIG. 1D is a front view of the example display of FIG. 1C.

FIG. 1E is the example embodiment of FIG. 1A with a different electrode state.

FIG. 1F is a front view of the example display of FIG. 1E.

FIG. 2A is a cross-section side view of part of an alternative example embodiment of a display.

FIG. 2B is a front view of the example display of FIG. 2A.

FIG. 2C is the example embodiment of FIG. 2A with a different electrode state.

FIG. 2D is a front view of the example display of FIG. 2C.

FIG. 2E is the example embodiment of FIG. 2A with a different electrode state.

FIG. 2F is a front view of the example display of FIG. 2E.

FIG. 2G is the example embodiment of FIG. 2A with a different electrode state.

FIG. 2H is a front view of the example display of FIG. 2G.

FIG. 3A is a cross-section side view of part of an alternative example embodiment of a display.

FIG. 3B is a cross-section front view of the example display of FIG. 3A.

FIG. 3C is the example embodiment of FIG. 3A, but with two optional differences.

FIG. 4A is a cross-section side view of part of an alternative example embodiment of a display.

FIG. 4B is a front view of the example display of FIG. 4A.

FIG. 5A is a cross-section side view of part of an alternative example embodiment of a display.

FIG. 5B is a front view of the example display of FIG. 4A.

FIG. 6A is a cross-section side view of an example embodiment of part of a display being assembled.

FIG. 6B is a cross-section side view of the example display of FIG. 6A after further assembly.

FIG. 7 is a cross-section side view of an example embodiment of part of a display being assembled.

FIG. 8A is a cross-section side view of an example embodiment of part of a display being assembled.

FIG. 8B is a cross-section side view of the example display of FIG. 8A after further assembly.

FIG. 9A is a flow chart of an example embodiment of a method of manufacturing.

FIGS. 9B, 9C, and 9D are flow charts of alternative examples of detail for a step of FIG. 9A.

### DETAILED DESCRIPTION

In the example displays described below, each cell extends to the back of the display, and each cell overlaps with at least one other cell. In some embodiments, each cell extends to both the front and back of the display. All active electrodes may be in a single layer at the back of the display. Eliminating the need for stacking multiple layers of cells, and eliminating the need for an intermediate layer of electrodes, reduces the cost of the display, simplifies manufacturing, and reduces complexity, particularly for a full-color display. Having only a single layer of cells also facilitates providing a flexible display.

In the following discussion, example embodiments are used to illustrate how colorants can be concentrated or spread out to form various combinations of colors in overlapping cells. Then, example embodiments illustrate how two colorants can be combined in one cell to provide a larger color gamut. More example embodiments then illustrate how cavities or recessed areas can be used to provide a clear state, for an even larger color gamut. Then example embodiments illustrate cells overlapping multiple other cells in one dimension, and cells overlapping multiple other cells in two dimensions.

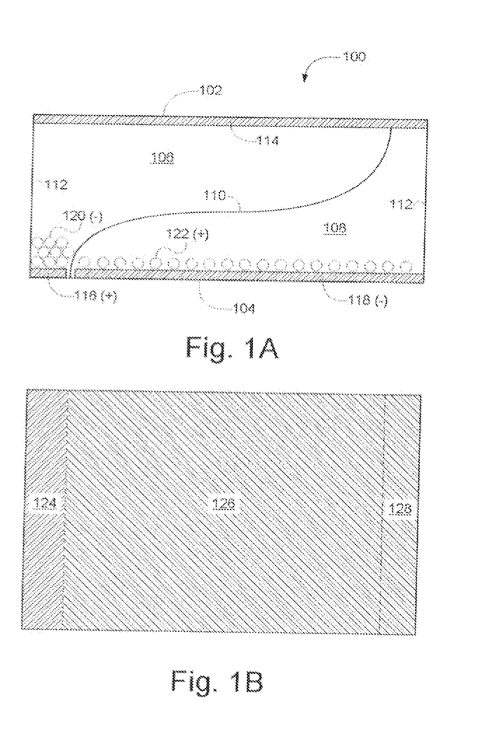

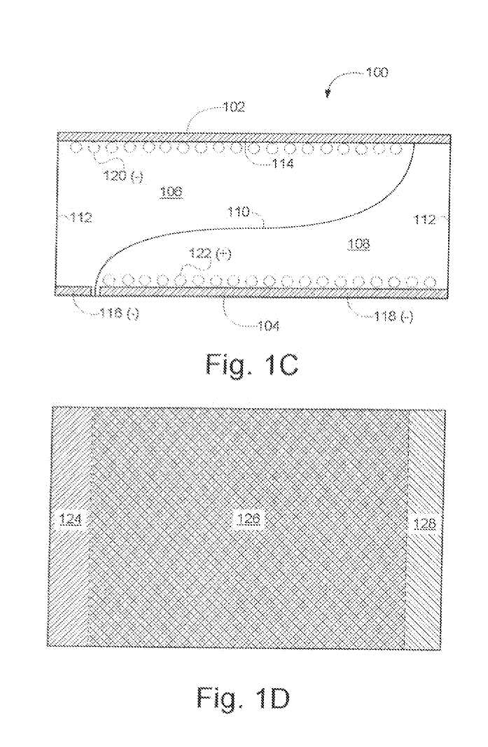

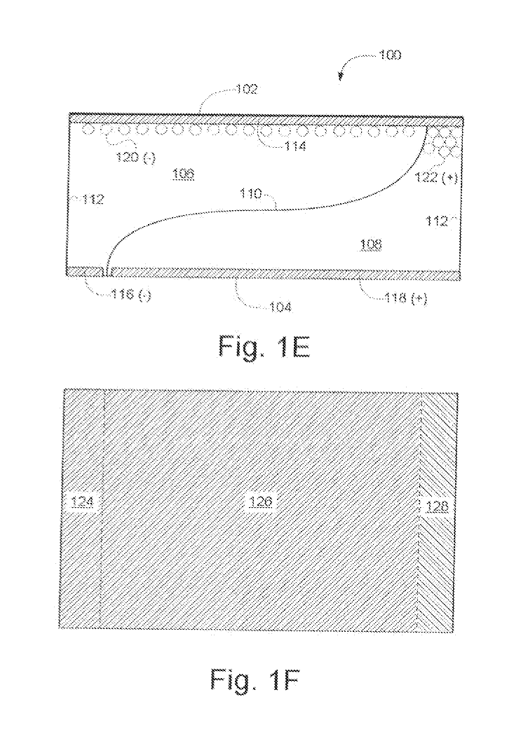

FIG. 1A illustrates a cross-section view of an example embodiment of an electro-optical display. In FIG. 1A, a display element 100 includes a front (viewing) surface 102, a back surface 104, and two cells (106, 108). The display element 100 may represent a pixel or part of a pixel (part of one row or part of one column of a display), with each row or column comprising thousands of display elements or pixels. Each cell is filled with a transparent fluid. Cells 106 and 108 are separated by a transparent wall or membrane 110 that is non-perpendicular to the front surface 102. Dividing walls or membranes 112 between display elements 100 may or may not be transparent. As seen through the front surface 102, cells 106 and 108 almost completely overlap. There is a passive (for example, grounded) transparent electrode 114 on the front surface of the display, and active (variable voltage) electrodes (116, 118) on the back side of each cell. There may be an optional dielectric layer separating the electrodes from fluid in the cells.

In the example of FIGS. 1A-1F, each cell includes one colorant. Cell 106 includes a negatively charged colorant 120, and cell 108 includes a positively charged colorant 122. The colorants are depicted as round particles, but they may be pigments, inks or fluids. Depending on the state of the active electrodes (116, 118), each cell has two possible states: (1) the colorant is concentrated near a narrow face of the cell; (2) the colorant is spread along a wide face of the cell.

In FIG. 1A, electrode 116 is positive, and negatively charged colorant 120 is concentrated in a narrow portion of cell 106 near electrode 116, and electrode 118 is negative, and positively charged colorant 122 is spread out along electrode 118. In FIG. 1B, as seen from the front of the element 100, area 124 is the color of light filtered by colorant 120, and areas 126 and 128 are the color of light filtered by colorant 122. In FIG. 1C, electrode 116 is negative, and negatively charged colorant 120 is spread out along the front electrode 114, and electrode 118 is negative, and positively charged colorant 122 is spread out along electrode 118. In FIG. 1D, as seen from the front of the element 100, area 124 is the color of light filtered by colorant 120, area 126 is the color of light filtered by both colorants 120 and 122, and area 128 is the color of light filtered by colorant 122. In FIG. 1E, electrode 116 is negative, and negatively charged colorant 120 is spread out along the front electrode 114, and electrode 118 is positive, and positively charged colorant 122 is concentrated in a narrow portion of cell 108 near the front electrode 114. In FIG. 1F, as seen from the front of the element 100, areas 124 and 126 are the color of light filtered by colorant 120, and area 128 is the color of light filtered by colorant 122.

In FIGS. 1A-1F, areas 124 and 128 are depicted as being relatively wide to facilitate illustration. The ratio of area 126 over areas 126 and 128 or 126 and 124 defines the clear aperture ratio. While it is desirable to have a larger clear aperture, the speed of spreading and movement of charged colorants depend on the geometry of the cells. As will be discussed further below, each cell preferably has a sufficient area in contact with both the front and back electrodes to permit some charge transfer and current flow. However, the widths of areas 124 and 128 may be made sufficiently narrow so that they are imperceptible to the human eye. The human eye will integrate color over an area larger than the area of an element, so that the net effect of areas 124 and 128 on color perception may be made insignificant. However, areas 124 and 128 may contribute to aliasing, moiré patterns, or other visual artifacts, and alternative example embodiments discussed below can reduce visual artifacts while optimizing performance of the electro-optical display.

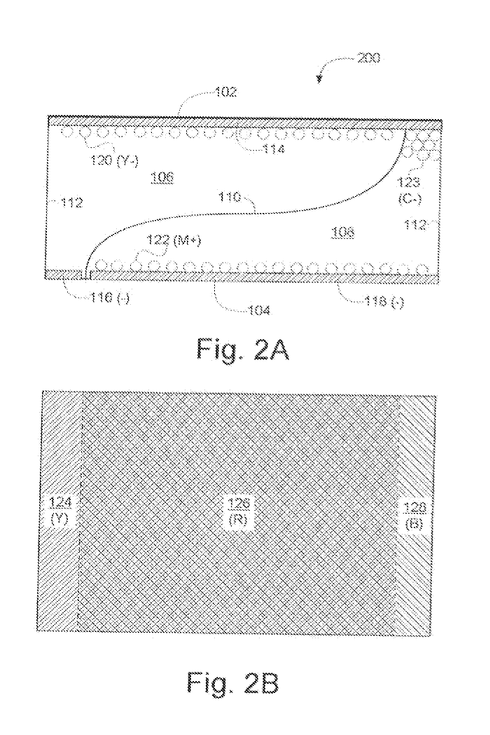

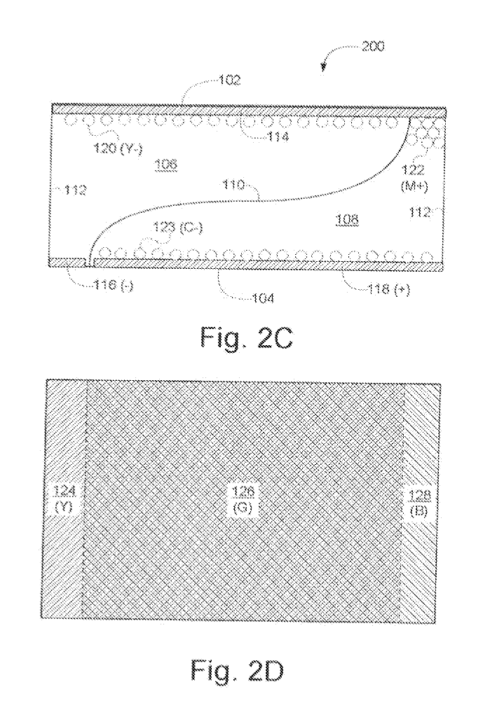

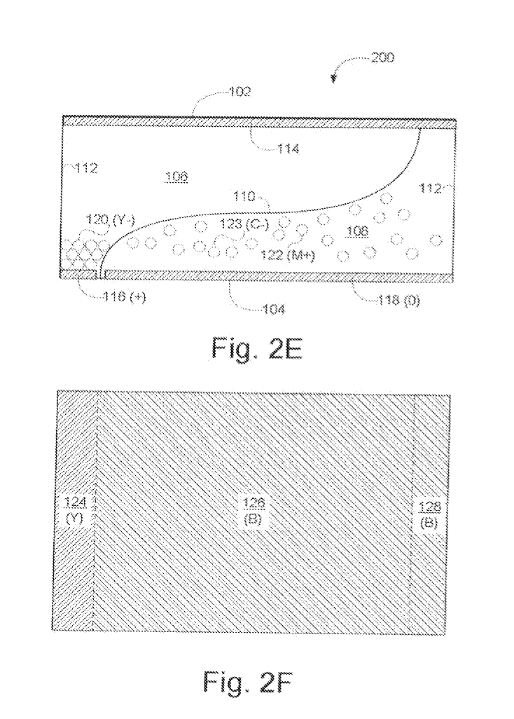

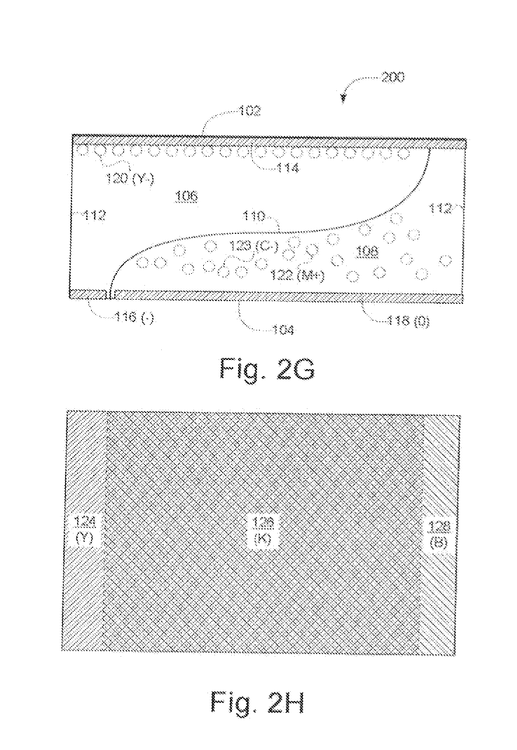

In the example embodiment of FIGS. 1A-1F, each cell has a single colorant. In the example of FIG. 2A, the element 200 has the same structure as element 100 in FIG. 1A (same reference numbers refer to identical structural elements), but cell 108 has two colorants (122 and 123). In the example of FIG. 2A, cell 108 has three states: (1) a first colorant is concentrated into a narrow portion of the cell near front electrode 114, and a second colorant is spread out along electrode 118; (2) the first colorant is spread out along electrode 118 and the second colorant is concentrated into a narrow portion of the cell near front electrode 114; (3) both colorants are dispersed throughout the cell. An example method for dispersing colorant throughout a cell will be discussed in more detail below.

Given an appropriate choice of colorants, the example embodiment of FIG. 2A can provide three primary colors plus black. In the following discussion, it is assumed that the colorants are subtractive, and that white light passes through the colorants. Assume, for example, that the negatively charged colorant 120 in cell 106 is yellow, assume that the positively charged colorant 122 in cell 108 is magenta, and assume that the negatively charged colorant 123 in cell 108 is cyan.

In each of the following examples, the front electrode 102 may be grounded. In FIG. 2A, electrode 116 is negative, and the negatively charged yellow colorant 120 is spread out along the front electrode 114, electrode 118 is negative, the positively charged magenta colorant 122 is spread out along electrode 118, and the negatively charged cyan colorant 123 is concentrated in a narrow portion of cell 108 near the front electrode 114. In FIG. 2B, as seen from the front of the element 200, area 124 is yellow, area 126 is red, and area 128 is blue. In FIG. 2C, electrode 116 is negative, and the negatively charged yellow colorant 120 is spread out along the front electrode 114, electrode 118 is positive, the negatively charged cyan colorant 123 is spread out along electrode 118, and the positively charged magenta colorant 122 is concentrated in a narrow portion of cell 108 near the front electrode 114. In FIG. 2D, as seen from the front of the element 200, area 124 is yellow, area 126 is green, and area 128 is blue. In FIG. 2E, electrode 116 is positive, and the negatively charged yellow colorant 120 is concentrated in a narrow portion of cell 106 near electrode 116, electrode 118 is neutral, and the positively charged magenta colorant 122 and the negatively charged cyan colorant 123 are dispersed throughout cell 108. In FIG. 2F, as seen from the front of the element 200, area 124 is yellow, and areas 126 and 128 are blue. In FIG. 2G, electrode 116 is negative, and the negatively charged yellow colorant 120 is spread out along the front electrode 114, electrode 118 is neutral, and the positively charged magenta colorant 122 and the negatively charged cyan colorant 123 are dispersed throughout cell 108. In FIG. 2H, as seen from the front of the element 200, area 124 is yellow, area 126 is black (K), and area 128 is blue.

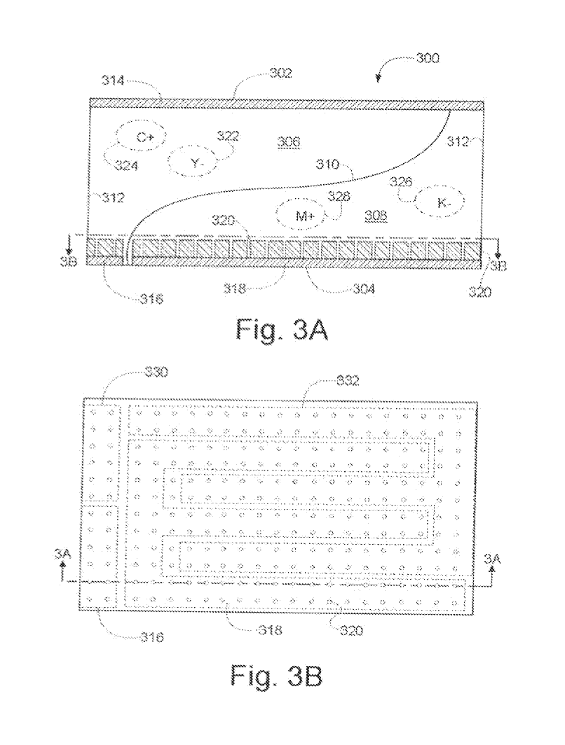

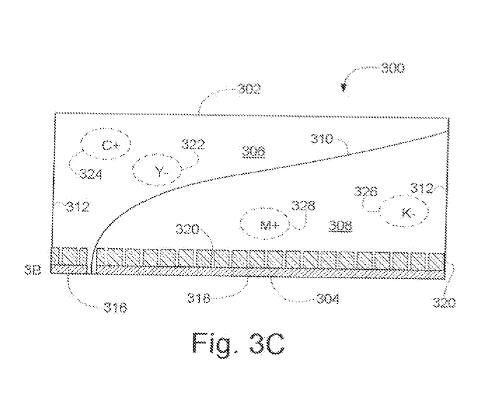

In FIGS. 1A-1F, each cell has a single colorant. In FIGS. 2A-2H, a front cell has a single colorant, and a back cell has two colorants. In the example embodiments of FIGS. 1A-1F and 2A-2H, the front cell 106 can achieve a clear state by concentrating its single colorant in a narrow portion of the cell. In the example embodiments of FIGS. 2A-2H, the back cell 108 always has at least one colorant dispersed, so there is no clear state for the back cell. In particular, with no clear state in the back cell, there is no white in a subtractive color system. This is solved in the following example embodiments. In the examples of FIGS. 3A-3C, each cell has two colorants. In addition, in the examples of FIGS. 3A-3C, each cell can achieve a clear state. Having two colorants per cell, and each cell having a clear state, provides a wider color gamut and a white state, as will be discussed further below.

In the example of FIG. 3A, a display element 300 includes a front (viewing) surface 302, a back surface 304, and two cells (306, 308). Cells 306 and 308 are separated by a transparent wall or membrane 310 that is non-perpendicular to the front surface 302. Dividing walls or membranes 312 between display elements may or may not be transparent. There is a passive (for example, grounded) transparent electrode 314 on the front surface of the display, and active (variable voltage) electrodes (316, 318) on the back side of each cell. There is a dielectric layer 320 between the active electrodes and the cells. The dielectric layer 320 has an array of cavities (or recessed areas) 320. In the example of FIG. 3A, cell 306 includes a negatively charged yellow colorant 322, and a positively charged cyan colorant 324. In the example of FIG. 3A, cell 308 includes a negatively charged black (K) colorant 326, and a positively charged magenta colorant 326.

FIG. 3B is a cross-section front view of the display of FIG. 3A, providing additional detail for example arrangements of cavities and electrode plates. In the example embodiment of FIG. 3B, front cell 306 has two rectangular electrode plates; plate 316 (visible in FIG. 3A) and plate 330 (not visible in the cross-section of FIG. 3A). Back cell 308 has two interleaved electrode plates; plate 318 (visible in FIG. 3A) and plate 332 (not visible in the cross-section of FIG. 3A). Interleaved electrode plates allow colorants to migrate a shorter distance and allow uniform distribution of colorant across a wide viewing window. However, the shape of electrodes may vary. For example, in the smaller area next to electrodes 316 and 330 it may not be practical to interleave electrodes in the small space (and there is less of a need where there is not a wide area and colorant particles are designed to compact, rather than uniformly spread across) so the electrodes are depicted as being rectangular.

In the example embodiment of FIGS. 3A and 3B, when a colorant is attracted to an active electrode, it is concentrated into the cavities 320. In the example embodiment of FIGS. 3A and 3B, each cell has four states: (1) both colorants are concentrated into cavities; (2) a first colorant is dispersed throughout the cell and the second colorant is concentrated into cavities; (3) the first colorant is concentrated in cavities and the second colorant is dispersed throughout the cell; (4) both colorants are dispersed throughout the cell.

Assume, for example, for cell 306, that electrode plates 316 and 330 are positive (relative to the charges on the colorants, and relative to the front electrode 314). The negatively charged yellow colorant 322 will be attracted (concentrated) into the cavities 320. Similarly, if electrode plates 316 and 330 are negative, then the positively charged cyan colorants 324 will be attracted (concentrated) into the cavities 320. If, for example, electrode 316 is positive, and electrode 330 is negative, then the negatively charged yellow colorant 322 will be concentrated into cavities 320 near electrode 316, and the positively charged cyan colorant 324 will be concentrated into cavities 320 near electrode 330. Similarly, for cell 308, electrode plates 318 and 332 may be charged to concentrate magenta, or black, or both magenta and black colorants into cavities 320. As will be discussed further below, instead of both electrodes being at a constant bias, the bias on one electrode can be modulated to provide a variable optical density. If cavities 320 near an electrode plate contain concentrated colorant, then briefly applying a negative charge to the electrode plate will cause the concentrated colorant to disperse.

In the following discussion, it is assumed that the colorants are subtractive, and that white light passes through the colorants. Assume for example that in the front cell 306, the yellow colorant 322 is dispersed and the cyan colorant 324 is concentrated into the cavities 320, and assume that in the back cell 308, the magenta colorant 326 is dispersed and the black colorant 328 is concentrated in the cavities 320. The perceived color of the overlapping cells as seen from the front will be red. The table below lists eight states of interest for the two cells (there are 16 possible combinations, but nine of the 16 possible states result in the same perceived color (black).

TABLE 1

| BACK CELL | | FRONT CELL | | PERCEIVED |
|---|---|---|---|---|
| BLACK | MAGENTA | YELLOW | CYAN | COLOR |
| CONCENTRATED | CONCENTRATED | CONCENTRATED | CONCENTRATED | CLEAR |
| CONCENTRATED | CONCENTRATED | CONCENTRATED | DISPERSED | CYAN |
| CONCENTRATED | CONCENTRATED | DISPERSED | CONCENTRATED | YELLOW |
| CONCENTRATED | CONCENTRATED | DISPERSED | DISPERSED | GREEN |
| CONCENTRATED | DISPERSED | CONCENTRATED | CONCENTRATED | MAGENTA |
| CONCENTRATED | DISPERSED | CONCENTRATED | DISPERSED | BLUE |
| CONCENTRATED | DISPERSED | DISPERSED | CONCENTRATED | RED |
| DISPERSED | DISPERSED | DISPERSED | DISPERSED | BLACK |

With two active back electrodes per cell (as in the example embodiment illustrated in FIGS. 3A and 3B), the passive front electrode 114 is preferable, but not necessary. In addition, if the active electrode arrangement permits elimination of the front electrode, then it is not necessary for the back cell(s) to extend to the front of the display. FIG. 3C illustrates the example embodiment of FIG. 3A with the front electrode eliminated, and the separating wall or membrane 310 does not extend to the front of the display. Eliminating the front electrode does not affect the number of states. That is, the necessary currents can flow from one active back electrode to another active back electrode without requiring a passive front electrode. However, a front electrode may help spreading of colorant along the z-axis (perpendicular to the front face). In addition, a front electrode can be grounded to provide a separate potential relative to the back electrodes.

In the arrangement illustrated in FIGS. 1A-1F, 2A-2H, and 3A-3B, each cell overlaps with only one other cell, in the same row or column.

Alternatively, other three-dimensional shapes may be used that provide overlap of multiple adjacent cells in the same row or column, or provide overlap of adjacent rows and columns. In particular, it is not necessary for all cells to be the same size or shape (for example, Penrose tiling), and it is not necessary for overlapping cells to be symmetrical. It is not necessary for a shared wall or membrane to be rigid or straight. In addition, it is not necessary to have a uniform thickness in shared walls, but instead it is only necessary to have some overlap of cells as seen from the front surface.

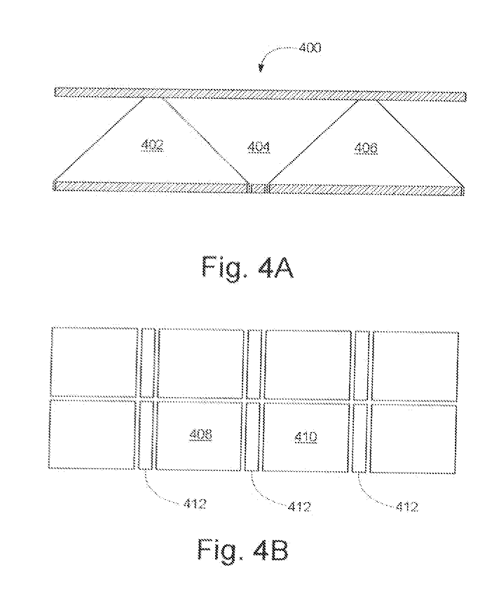

For one example, FIGS. 4A and 4B illustrate part of an array of cells that overlap in two dimensions. FIG. 4A is a cross-section side view and FIG. 4B is a front view. FIGS. 4A and 4B are simplified to facilitate illustration. In FIG. 4A, there are three cells (402, 404, 406). In FIG. 4B, area 408 illustrates the overlap of cells 402 and 404, and area 410 illustrates the overlap of cells 404 and 406. Areas 412 illustrate areas of no overlap. The example configuration of FIG. 4A may be implemented as in FIG. 2A, with one colorant in the front cells (404), and two colorants in the back cells (402, 406). Alternatively, the example of FIG. 4A may be implemented as in FIG. 3A, with cavities in the back and two colorants in each cell.

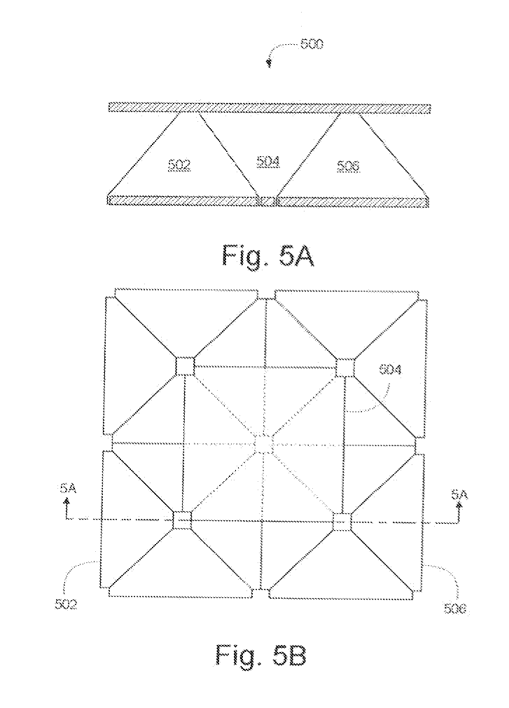

As another example, FIGS. 5A and 5B illustrate part of an array of cells that overlap in two dimensions. FIG. 5A is a cross-section side view and FIG. 5B is a front view. In FIGS. 5A and 5B, a display 500 is depicted as having five cells (simplified to facilitate illustration), all of which are at least partially visible in front view 5B, and three of which are visible in the cross-section view in FIG. 5A. In FIG. 5A, there are three visible cells (502, 504, 506). Each cell is a four-sided pyramid with a square base and a truncated peak. Each cell overlaps with four other cells, as can be seen in FIG. 5B where cell 504 overlaps with four other cells, including cells 502 and 506. As drawn, cell 504 only touches cells 502 and 506 at the corners (no common sides), but as discussed above, there is still overlap of colorant volumes, and as long as the cells are formed from a transparent material then color mixing will take place as light passes through overlapping cells. Each cell may contain two colorants. Each cell may have multiple electrode plates (not illustrated in FIG. 5B), and electrode plates for large viewing areas may be interleaved as illustrated in FIG. 3B.

One particular advantage of the example of FIGS. 5A and 5B is that the arrangement provides a gradation of colorant density for each colorant even without controlling the optical density of a colorant (discussed further below). For example, within the viewing area of the front surface of cell 504, for one colorant, for example magenta, one-fourth of the area may be magenta, or half, or three-fourths, etc. This enables a broader color gamut and grayscale. In addition, in the example arrangement of FIGS. 5A and 5B, visual artifacts are reduced because of the arrangement of small areas with no overlap. Another advantage of the examples of FIG. 5A over the example of FIG. 3A is that the worst case distance for colorant to travel, in a direction parallel to the front, from a dispersed state to a concentrated state (or vice versa), is reduced by half. For example, in FIG. 3A, a dispersed colorant particle in the upper right corner might have to traverse the entire width of cell 308 to become compressed near electrode 318, whereas in FIG. 5A, a colorant particle at the apex of a prism or pyramid only has to traverse at most half of the width of the base of the prism or pyramid. Switching time has a quadratic dependence on travel distance, so switching speed for the example of FIG. 5A may be four times faster than the switching speed for the example of FIG. 3A.

The total area of the cavities is sufficiently less than the area of the cells to provide optical contrast when colorant is concentrated into the cavities. The shape, number, size, and distribution of cavities in FIGS. 3A and 3B is just for illustration, and the shape, number, size and distribution may vary. For example, the cavities may be a uniform array, or may be randomly placed, with the electrode plates determining which cavities are actively used. The primary requirement for the cavities is that the total volume of the cavities adjacent to an electrode plate must be sufficient to hold all of one colorant in a cell.

The color discussion above assumes a subtractive color system. However, overlapping cells may also be used with an additive color system. White colorants may optionally be provided, and the white colorant may be reflective. One or both overlapping cells may contain only a single colorant. Filters may optionally be fabricated onto the front surface of the cells to provide even more flexibility in color. In addition, one or both cells may have a fluid that is tinted or dyed so when colorants are concentrated the cell has the color of the fluid (as opposed to a clear state).

Many displays for applications such as e-books do not use back illumination (to save power). That is, external light enters the front of the display element and is reflected from the back. For example, in FIG. 1A there may be a reflective layer on the front side of electrodes 116 and 118, or in FIG. 3A there may be a reflective layer on the front side or back side of layer 320. Note, however, that overlapping cells may also be used with a backlit display. In general, if light passes through a cell only once (transmissive) then the cell needs twice the optical density of a cell for which light passes through twice (reflective).

In each of the example embodiments, there are active electrode plates only on the back side of the display. Active electrode plates may optionally be placed on both front and back surfaces, but having active electrodes on only one side reduces cost and improves manufacturability.

There are multiple suitable colorant technologies, for example, charged pigment particles, charged inks, and oil films (electrowetting). There are also multiple physical principles that may be used to repel, attract, move, compress, concentrate, or disperse the colorants, for example: electrokinetics, electrophoretics, electrowetting, and electrofluidics. The movement of colorant in displays as illustrated in FIGS. 1A, 2A, 3A, 3C, 4A, and 5A may be more than just electrophoretic. While in electrophoretic displays, charged colorants move along electric field lines, movement of colorant in displays as depicted in FIGS. 1A, 2A, 3A, 3C, 4A and 5A may include convective flow of parts of the fluid, with charge transfer to direct movement of the charged colorants. A more detailed discussion may be found in U.S. application Ser. No. 12/411,828 filed Apr. 30, 2009.

If a colorant is concentrated (in cavities or near an electrode), the concentrated colorant may be dispersed by briefly applying a same-polarity bias to the electrode plate adjacent to the concentrated colorant. Colorant dispersal (optical density) may also be actively controlled to provide variable lightness or a gray scale. For example, by applying periodic pulses to an electrode, and by varying the pulse amplitude or pulse width, charged colorant stagnates at dynamic equilibrium between compacted and spread states to provide variable optical density. This variable optical density may be implemented either in embodiments with a passive front electrode or in embodiments such as FIG. 3C where there is no front electrode. That is, without a front electrode, one electrode may be held at a bias sufficient to hold one colorant and the other electrode can be modulated to provide variable optical density of the other colorant. Once colorants are dispersed, they stay dispersed, and bias can be removed from the active electrodes. Once colorants are concentrated, only a very small amount of current is required to hold that state. Accordingly, for displays as disclosed, the power required when the image is not changing is relatively insignificant.

The cells may be fabricated from transparent plastic (for example, polyethylene terephthalate (PET)), and may be sufficiently thin so that the display is flexible. Overall cell thickness from front to back may be on the order of a few hundred micrometers or less. Cell volumes as illustrated in FIGS. 1A, 2A, 3A, 3C, 4A, and 5A may be fabricated by molding or double-sided embossing in one step, and then front and back surfaces and electrode plates may be added.

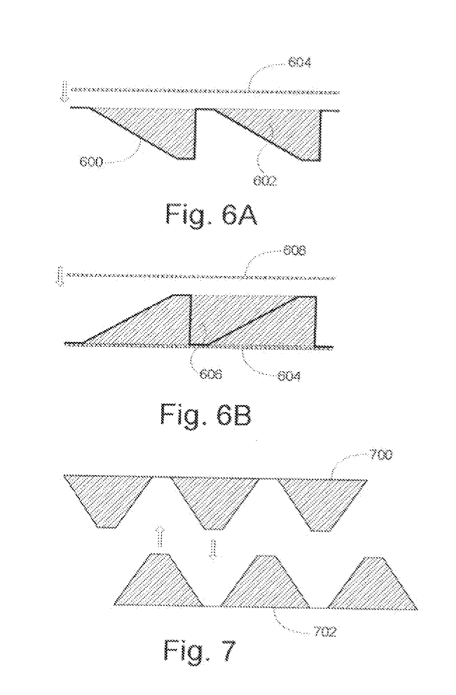

For example, in FIG. 6A, an internal structure 300 has been formed (corresponding to the internal structure of the embodiment of FIGS. 1A, 2A, 3A), and what will become the back cells have been filled with a fluid and colorant(s) 602. A back wall 604 (with previously fabricated electrodes) may then be attached. In general, electrodes and cavity filled dielectrics need to be fabricated before cells are filled with fluid (as opposed to fabricating onto cells already containing fluid). In FIG. 6B, the filled and sealed structure from FIG. 6A is turned over, and what will become the front cells have been filled with a fluid and colorant(s) 606. A front wall 608 may then be attached.

Alternatively, the structure may be assembled from two substrates. For example, in FIG. 7, one substrate 700 (corresponding, for example, to the front cells of FIGS. 4A and 5A) has been formed, filled and sealed. A second substrate 402 (corresponding, for example, to the back cells of FIGS. 4A and 5A) has been formed, filled, and sealed. The two substrates may then be joined.

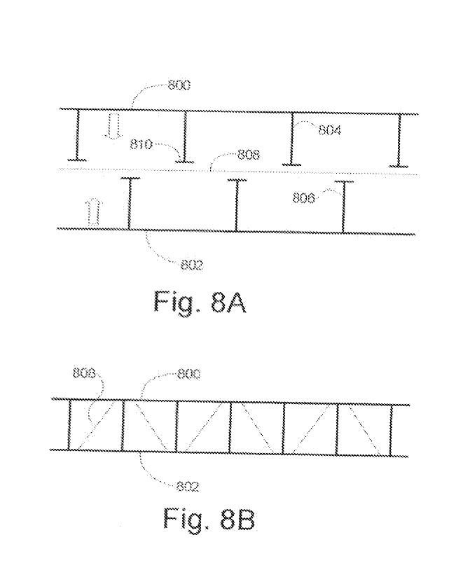

As still another alternative using two substrates, overlapping cells may be separated by a flexible membrane. For example, in FIG. 8A, a transparent wall 800 corresponds to front surface 102 in FIG. 1A, a wall 802 corresponds to back surface 104 in FIG. 1A, and walls 804 and 806 correspond to walls 112 in FIG. 1A. A flexible transparent membrane 808 corresponds to element 110 of FIG. 1A when stretched into place. A “T” 810 at the end of each wall 804 and 806 forms an area corresponding to the back wall adjacent to electrode plate 116 in FIG. 1A and the narrow front portion of cell 108 in FIG. 1A. In FIG. 8B, as the two substrates are forced together, membrane 808 is stretched into place to divide cells as illustrated in FIG. 1A. If the walls in FIG. 8A are eliminated on one side (for example, eliminating walls 806), the membrane stretches to form a structure as in FIGS. 4A and 4B. If elements 804 and 806 are posts instead of walls, then with properly spaced posts, the membrane 808 stretches to form a structure functionally similar to the structure of FIGS. 5A and 5B. Cell volumes on one side may be filled with fluid and colorants, then the membrane may be added, and then fluid and colorants may be added on top of the membrane and sealed.

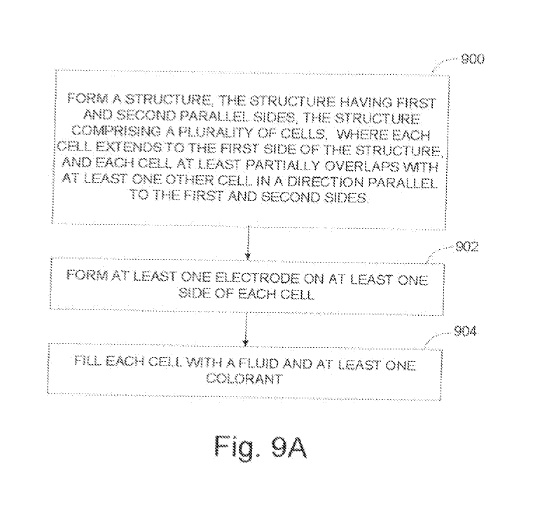

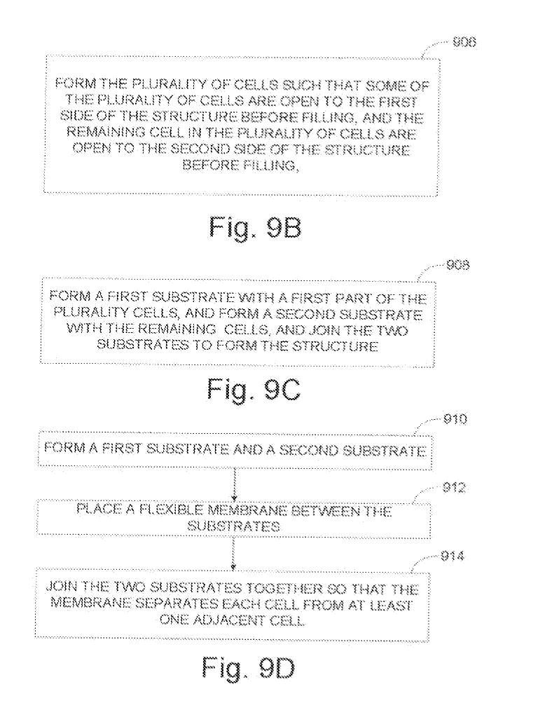

FIG. 9A is a flow chart of an example embodiment of a method of manufacturing. At step 900, a structure is formed, the structure having first and second parallel sides, the structure comprising a plurality of cells, where each cell extends to the first side of the structure, and at least one cell at least partially overlaps with at least one other cell in a dimension parallel to the first and second sides. At step 902 at least one electrode is formed on at least one side of each cell. At step 904, each cell is filled with a fluid and at least one colorant.

FIG. 9B is a one alternative for additional detail for step 900. At step 906, the cells are formed such that some of the plurality of cells are open to the first side of the structure before filling, and the remaining cells are open to the second side of the structure before filling (for example, as in FIG. 6A).

FIG. 9C is another alternative for additional detail for step 900. At step 908, two substrates are formed, with part of the cell on each substrate, and then the two substrates are joined to form the structure (for example, as in FIG. 7).

FIG. 9D is still another alternative for additional detail for step 900. At step 910, two substrates are formed. At step 912, a flexible membrane is placed between the two substrates. At step 914, the two substrates are joined so that the membrane separates each cell from at least one adjacent cell (for example, as in FIG. 8B).

What is claimed is:

1. A display, comprising:
a front surface, a back surface, at least a first cell and a second cell, each cell filled with a fluid containing at least one colorant, each cell extending to the back surface; and,
the first and second cells having at least partially overlapping volumes so that for at least a portion of the front surface, a line perpendicular to the front surface passes through both the first cell and the second cell.

2. The display of claim 1, where each cell extends to the front surface and to the back surface.

3. The display of claim 1, where the first cell has an overlapping volume with a plurality of other cells.

4. The display of claim 1, further comprising: each cell having a front and a back, and for each cell, one of the cell front and cell back being substantially larger than the other of the cell front and cell back.

5. The display of claim 1, further comprising: at least one electrode adjacent to each cell, each electrode capable of attracting a colorant in the cell adjacent to the electrode so that the colorant is near the electrode.

6. The display of claim 5, further comprising: active electrodes only on the back surface.

7. The display of claim 6, further comprising: a passive electrode on the front surface.

8. The display of claim 6, further comprising: no passive electrode on the front surface.

9. The display of claim 5, further comprising: active electrodes on the front and back surfaces.

10. The display of claim 1, further comprising:
each cell having two charged colorants of opposite polarity; and
each cell having a state in which one colorant is dispersed into the cell volume and the other colorant is near an electrode.

11. The display of claim 5, further comprising: a dielectric layer formed on at least one electrode, the dielectric layer patterned with at least one recessed area or cavity in which colorant can be concentrated.

12. A method of manufacturing a display, comprising:
forming a structure, the structure having first and second parallel sides, the structure comprising a plurality of cells, where each cell extends to the first side of the structure and at least one cell at least partially overlaps at least one other cell in a dimension perpendicular to the first and second sides;
forming at least one electrode on at least one side of each cell; and, filling each cell with fluid and at least one colorant.

13. The method of claim 12, the step of forming a structure further comprising:
forming the plurality of cells such that some of the plurality of cells are open to the first side of the structure before filling, and the remaining cells are open to the second side of the structure before filling.

14. The method of claim 12, the step of forming a structure further comprising:
forming a first substrate with a first part of the plurality of cells, and forming a second substrate with the remaining cells, and joining the two substrates to form the structure.

15. The method of claim 12, the step of forming a structure further comprising:
forming a first substrate and a second substrate;
placing a flexible membrane between the substrates; and
joining the substrates together so that the membrane separates each cell from at least one adjacent cell.

16. A display, comprising:
a back surface, at least first and second cells, each cell extending to the back surface, and the first and second cells overlapping in a dimension transverse to the back surface;
means for concentrating a first colorant in the first cell;
means for dispersing the first colorant in the first cell;
means for concentrating a second colorant in the second cell; and,
means for dispersing the second colorant in the second cell.

17. The display of claim 16, further comprising:
two colorants in the first cell; and,
means for dispersing both of the two colorants in the first cell; and,
means for concentrating both of the two colorants in the first cell.

18. The display of claim 17, the means for concentrating both of the two colorants further comprising cavities.

19. A display, comprising:
first and second parallel sides;
a plurality of fluid-filled cells, each cell extending to the first side of the display;
a flexible membrane separating each cell from at least one adjacent cell; and,
at least one cell overlaps at least one other cell in a dimension perpendicular to the first and second sides.

20. A display, comprising:
first and second parallel sides;
a plurality of fluid-filled cells;
the cells at least partially overlapping so that some light passing through the display passes through more than one cell; and
active electrodes only on the first side.
